(19) United States
(12) Patent Application Publication
(10) Pub. No.: US 2023/0031865 A1
(43) Pub. Date: Feb. 2, 2023

(54) DEVICE, DISPLAY METHOD, AND RECORDING MEDIUM

(71) Applicant: Eiichiro YOSHIDA, Kanagawa (JP)

(72) Inventor: Eiichiro YOSHIDA, Kanagawa (JP)

(73) Assignee: Ricoh Company, Ltd., Tokyo (JP)

(21) Appl. No.: 17/814,954

(22) Filed: Jul. 26, 2022

(30) Foreign Application Priority Data
Jul. 29, 2021 (JP) 2021-124563

(51) Int. Cl. H04N 1/00; H04N 1/44

(52) U.S. Cl. CPC H04N 1/00435; H04N 1/444; H04N 1/00411

(57) ABSTRACT

A device includes circuitry; and a memory storing computer-executable instructions that cause the circuitry to execute displaying by an application, in a first area of a screen, information received from an information processing apparatus in a network; displaying, in a second area of the screen different from the first area, a display component that connects to a specified connection destination; and communicating to connect to the specified connection destination in response to detecting that the display component is pressed, wherein the displaying includes displaying, in the first area, connection destination information received from the specified connection destination.

### CROSS-REFERENCE TO RELATED APPLICATION

The present application is based on and claims priority under 35 U.S.C. § 119 to Japanese Patent Application No. 2021-124563, filed on Jul. 29, 2021, the contents of which are incorporated herein by reference in their entirety.

### BACKGROUND OF THE INVENTION

### 1. Field of the Invention

The present invention relates to a device, a display method, and a recording medium.

### 2. Description of the Related Art

When a user uses a device such as an image forming apparatus, it may be necessary to log in to the device or a server. This is to restrict unauthorized usage of the device and to charge a fee, apply a usage restriction, or the like, based on the authority of the user.

As a method of authenticating the user by the device, there is a method of authenticating the user inside the device and a method of using an external server (see, for example, Patent Document 1). Patent Document 1 discloses an image forming apparatus for performing an authentication by a process using an external server that is common to a plurality of applications (apps).
Patent Document 1: Japanese Patent No. 4976345

### SUMMARY OF THE INVENTION

According to one aspect of the present invention, there is provided a device including circuitry; and a memory storing computer-executable instructions that cause the circuitry to execute displaying by an application, in a first area of a screen, information received from an information processing apparatus in a network; displaying, in a second area of the screen different from the first area, a display component that connects to a specified connection destination; and communicating to connect to the specified connection destination in response to detecting that the display component is pressed, wherein the displaying includes displaying, in the first area, connection destination information received from the specified connection destination.

### BRIEF DESCRIPTION OF THE DRAWINGS

FIG. 1 is a diagram illustrating an example of screen transition of a screen displayed by a web browser operating on a Personal Computer (PC) according to an embodiment of the present invention;

FIG. 2 is a diagram illustrating an example of an authentication screen of an external server displayed by a web browser of a device according to an embodiment of the present invention;

FIG. 3 is a diagram illustrating an example of a system configuration of a device using system according to an embodiment of the present invention;

FIG. 4 is a diagram illustrating a hardware configuration of an example of an information processing system according to an embodiment of the present invention;

FIG. 5 is a diagram illustrating a hardware configuration of an example of a device according to an embodiment of the present invention;

FIG. 6 is a diagram illustrating a functional configuration of an example of a device using system according to an embodiment of the present invention;

FIG. 7 is a diagram illustrating an example of address information stored in an address information storage unit according to an embodiment of the present invention;

FIG. 8 is an example of a sequence diagram illustrating procedures in which the device communicates with an external server and the external server authenticates a user according to an embodiment of the present invention;

FIG. 9 is an example of a flowchart illustrating procedures in which the device displays a reload button according to an embodiment of the present invention;

FIG. 10 is a diagram illustrating an example of a message displayed when the reload button is pressed according to an embodiment of the present invention; and

FIG. 11 is a diagram illustrating an example of an editing drawing displayed in a web page section when an external server provides a PDF editing service according to an embodiment of the present invention.

### DESCRIPTION OF THE EMBODIMENTS

In the conventional technology, there has been a problem in that a display component that connects to a specified connection destination is not displayed in a second area that is different from a first area where the application displays the information. For example, there are cases where an authentication screen created for a personal computer (PC) is to be displayed on an operation panel of a device. However, an application (for example, a web browser) operating on the device may transition to a screen in which the authentication operation cannot be continued, because the function of such an application is more restricted compared to that of an application for a personal computer (PC). Applications can display various kinds of information, and, therefore, similar problems may arise not only on an authentication screen but also in other screens.

A problem to be addressed by an embodiment of the present invention is to provide a device that displays, in a second area that is different from a first area where the application displays information, a display component that connects to a specified connection destination.

Hereinafter, as an example of an embodiment of the present invention, a device and a display method performed by the device will be described with reference to the drawings.

### <Supplemental Explanation of Screen Transition of Screen Displayed by Device>

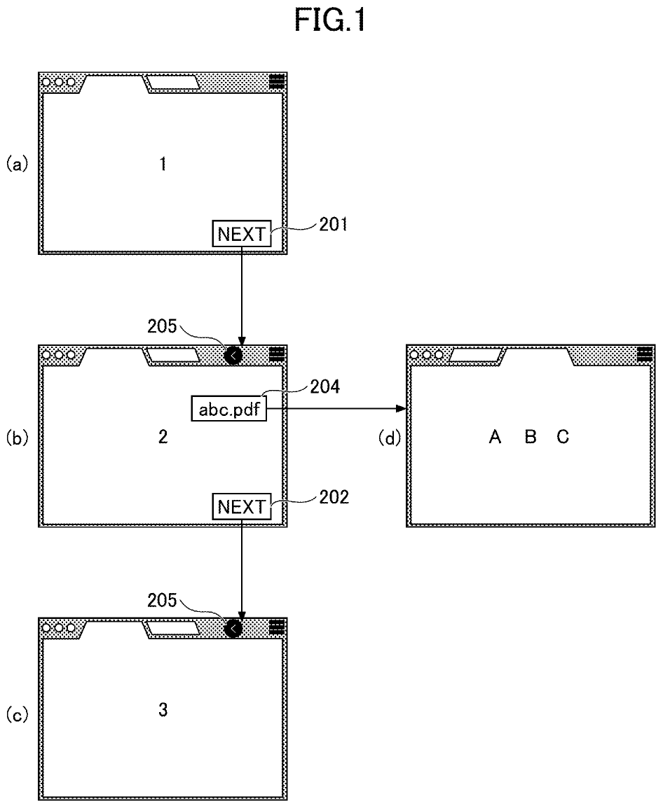

First, referring to FIG. 1, a supplemental explanation of the screen transition of the screen displayed by a device 20 is given. FIG. 1 illustrates the screen transition of a screen displayed by a web browser operating on a Personal Computer (PC) or the like. In FIG. 1, (a) illustrates page 1 of a series of articles, and when the user presses a button 201 indicating next, page 2 is displayed.

In FIG. 1, (b) illustrates page 2. Page 2 has transitioned from page 1, and, therefore, a button 205 to return is displayed on the web browser. When the user presses a button 202, page 3 is displayed.

In FIG. 1, (c) illustrates page 3. Page 3 has transitioned from page 2, and, therefore, a button 205 to return is displayed on the web browser.

Thus, a web browser displays the button 205 to automatically return with respect to the screen transition, but when the web page has transitioned to a different tab, a button for returning is not displayed. For example, if a user presses a Portable Document Format (PDF) file 204 (actually a link to a PDF file) on page 2, the web browser may display the PDF file on a separate tab (these settings are described on the original web page). In FIG. 1, (d) illustrates an example of a displayed PDF file, but the web browser does not display a button for returning because this web page is displayed on this tab for the first time. However, with respect to an operation to the PC, if the user wants to return to page 2, page 2 can be displayed by displaying the original tab.

When a web browser operating on a device such as an image forming apparatus displays a web page for a PC as described above, the web browser may not be supporting tabs. In a case where the web browser is not supporting tabs, if the user presses the PDF file displayed on page 2, the web browser will not display a return button. It is difficult for the user to switch tabs (in the first place, multiple tabs are not displayed), and, therefore, the user cannot return to page 2 (cannot return to page 1 or page 3 either). If the user performs an authentication operation on the device, the authentication operation cannot be continued.

### <Method of Returning to Screen According to the Present Embodiment>

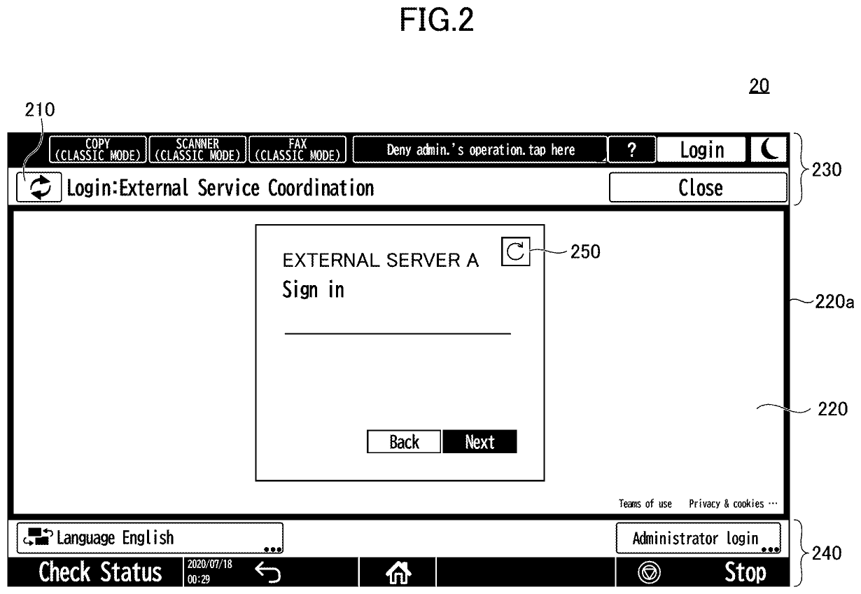

Accordingly, as illustrated in FIG. 2, in the present embodiment, the device 20 displays a reload button 210 (an example of a display component) on a display screen of a web browser operating in the device 20. The reload button 210 is a button that causes the screen to transition to a specified web page. FIG. 2 is an example of an authentication screen of an external server displayed by the web browser of the device 20. In FIG. 2, only the inside of a frame 220a (the frame is not displayed) is a web page section 220 (an example of a first area) displayed by the web browser, and the areas above and below the frame 220a are device display sections 230 and 240 (an example of a second area) displayed by a native application.

While the device 20 is communicating with an external server 40 to authenticate the user, the native application displays the reload button 210 outside the web page section 220 under certain conditions as described below. The native application may constantly display the reload button. Accordingly, even if the user causes the screen to transition to a screen from which it is difficult to return during the authentication operation, the user can press the reload button 210 to cause the screen to transition to the initial screen of the authentication operation, for example, so that the authentication by the external server 40 can be implemented again.

### <Terminology>

The specified connection destination is a connection destination that is associated with a button and is indicated by a Uniform Resource Locater (URL), for example. The specified connection destination is a URL that at least allows the user to continue the operation. The specified connection destination may be a connection destination URL where the initial screen at the beginning of the screen transition is displayed, for example, at an authentication site, or a specified URL for which the user has pressed a re-read button.

An application is software that is used for a specific function or purpose, and is not intended for operating the computer per se such as an operating system. In the present embodiment, a web browser is described as an example of an application. However, an application other than a web browser would be applicable as long as the application can display the server information.

A native application is an application that is executed after being installed in a terminal. A web application is an application that operates in the web browser without being installed.

A display component is a display of a color, a shape, or the like forming the screen. The display component is not a component that can be separated from the device, but rather, the display component is a component that a human being can visually distinguish from other parts of the screen. For example, buttons are display components.

### Example of System Configuration

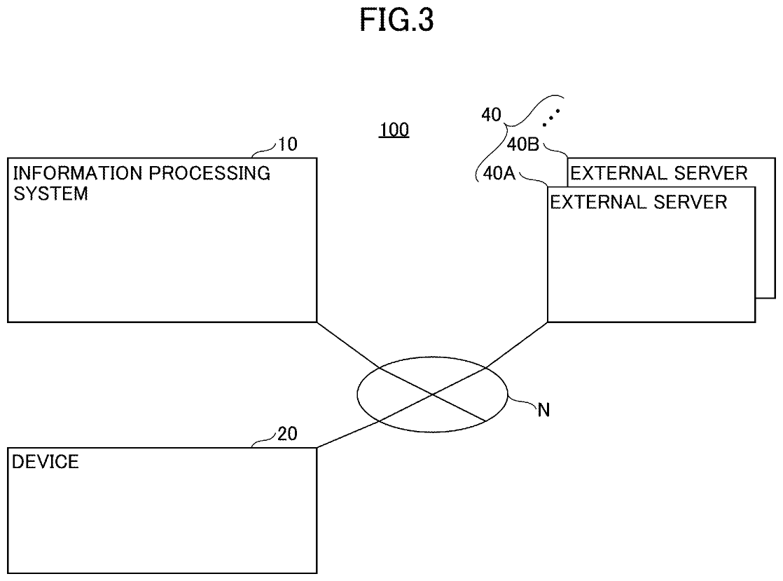

Referring to FIG. 3, a system configuration of a device using system 100 according to the present embodiment will be described. FIG. 3 is a diagram illustrating an example of a system configuration of the device using system 100 according to the present embodiment.

The device using system 100 illustrated in FIG. 3 includes an information processing system 10 and the device 20, which are communicatively connected via a wide area network N such as the Internet. The information processing system 10 may also communicate with a variety of the external servers 40.

The information processing system 10 is implemented in one or more information processing apparatuses and provides a variety of services to users via the network N, alone or in cooperation with a cloud service. The information processing system 10 according to the present embodiment provides a variety of services including, for example, workflow services that perform a series of processes such as scanning a document, Optical Character Recognition (OCR) of image data, uploading a file, and the like. Another example of a service is pull printing of files from a cloud service. Further, the present embodiment may be suitably applied to any relevant service requiring user authentication by the external server 40.

The information processing system 10 may be implemented by cloud computing or by a single information processing apparatus. Cloud computing is a form in which resources on a network are used without considering specific hardware resources. The information processing system 10 may be present on the Internet or on-premise.

The device 20 may be a variety of electronic devices used by the user. The device 20 may be, for example, an image forming apparatus such as a Multifunction Peripheral (MFP), a projector, an electronic blackboard, a video conference terminal, a digital camera, or the like. Further, the device 20 may be any relevant device in which a web browser operates. The device 20 can communicate with the information processing system 10 or the external server 40 via the network N. The user may use the device 20 to use various services provided by the information processing system 10 or the external server 40.

A plurality of the external servers 40 may be present depending on the function. The term “external” refers to a server that is separate from the information processing system 10. For example, the management of a service in the external server 40 may be different from that of the information processing system 10. When distinguishing the external servers 40, the external servers 40 are described as the external server 40A, the external server 40B, and the like, but when referring to any one of the external servers 40, the external server 40 is described simply as the “external server 40”. The external server 40 is one or more information processing apparatuses.

One of the external servers 40 has the function of authenticating a user. The external server 40 corresponds to, for example, OAuth. OAuth is a mechanism for operating multiple web services in cooperation with each other. Usually, in order to use a web service, it is necessary to input a user ID and a password individually to each web service to authenticate the user. However, using OAuth enables linkage between web services without having the user input the ID and password individually to each web service. The external server 40 authenticates the user of the device 20 in response to an authentication request from the information processing system 10.

To give a supplemental explanation, assuming the information processing system 10 does not authenticate the ID and password input to the device 20, but the external server 40 authenticates the ID and password, the information processing system 10 may transmit the ID and password, which are transmitted from the device 20, to the external server 40. In this case, the device 20 can receive, from the information processing system 10, an authentication screen optimized for the small operation panel of the device 20, and display the authentication screen. However, when considering the case where the information processing system 10 uses the authentication function of the external server 40 in order to reduce the authentication cost or the like, the Application Programming Interface (API) of the external server 40 does not accept authentication information such as an ID and a password. For this reason, it is considered to adopt a mechanism such as OAuth, but in the device 20, a web browser for being incorporated is used, and, therefore, there is a risk that an inconvenience as illustrated in FIG. 1 may occur.

### Example Hardware Configuration

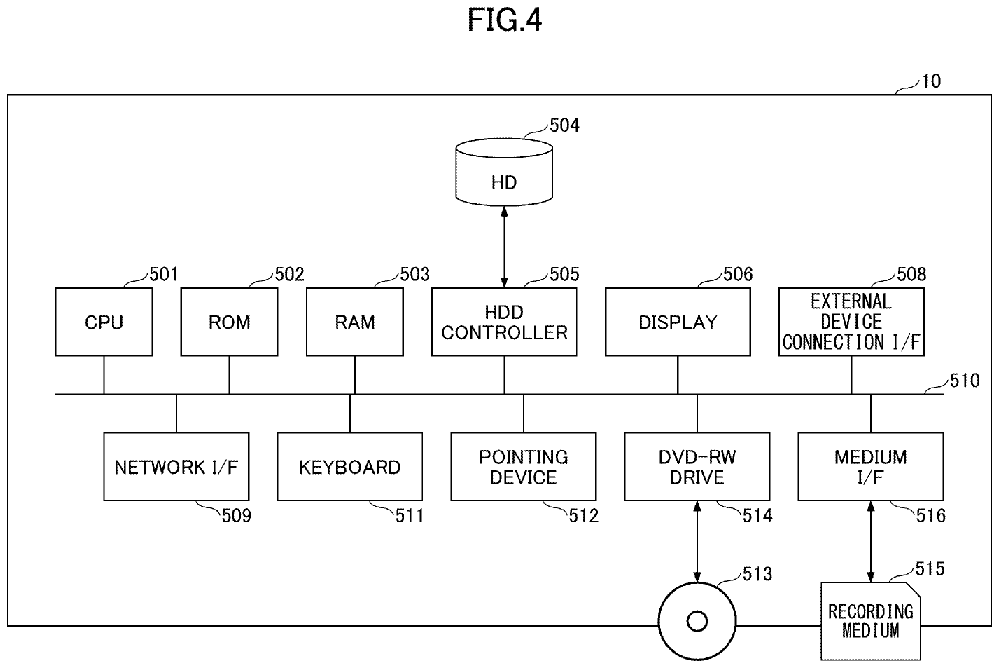

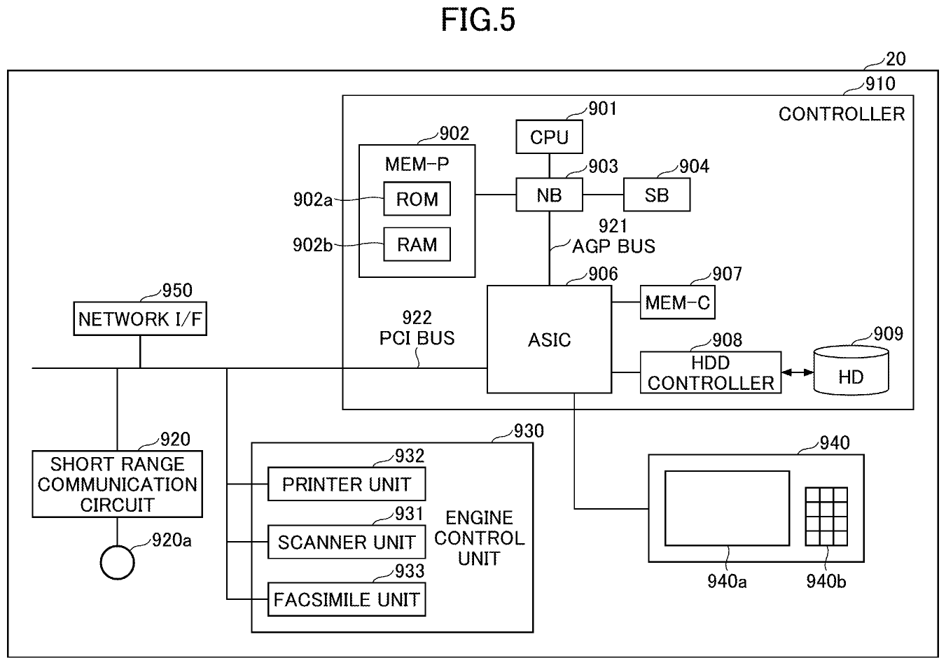

Referring to FIGS. 4 and 5, the hardware configuration of the information processing system 10 and the device 20 included in the device using system 100 according to the present embodiment will be described.

### <<Information Processing System>>

FIG. 4 is a diagram illustrating an example of hardware configuration of the information processing system 10 according to the present embodiment. The hardware configuration of the external server 40 may be the same as that in FIG. 4, or may be different, but the description of the present embodiment will not be affected either way.

As illustrated in FIG. 4, the information processing system 10 is constructed by a computer and includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a Digital Versatile Disc Rewritable (DVD-RW) drive 514, and a medium I/F 516.

Among these, the CPU 501 controls the operation of the entire information processing system 10. The ROM 502 stores a program used to drive the CPU 501, such as an initial program loader (IPL). The RAM 503 is used as the work area of the CPU 501. The HD 504 stores various kinds of data such as a program. The HDD controller 505 controls the reading or writing of various data from and to the HD 504 according to the control of the CPU 501. The display 506 displays various kinds of information such as cursors, menus, windows, characters, or images. The external device connection I/F 508 is an interface for connecting various external devices. In this case, the external device may be, for example, a Universal Serial Bus (USB) memory or a printer. The network I/F 509 is an interface for performing data communication by using the network N. The bus line 510 is an address bus, a data bus, or the like for electrically connecting elements such as the CPU 501 illustrated in FIG. 4.

Further, the keyboard 511 is a type of input means including a plurality of keys used for inputting information such as characters, numbers, or various instructions. The pointing device 512 is a type of input means for selecting and executing various instructions, selecting a processing target, moving a cursor, and the like. The DVD-RW drive 514 controls the reading or writing of various data from and to the DVD-RW 513 as an example of a removable recording medium. The DVD-RW drive 514 is not limited to the DVD-RW but may accommodate a Digital Versatile Disc Recordable (DVD-R) or the like. The medium I/F 516 controls the reading or writing (storage) of data from or to a recording medium 515, such as a flash memory.

### <<Device>>

FIG. 5 is a hardware configuration diagram illustrating an image forming apparatus that is an example of the device 20. As illustrated in FIG. 5, the image forming apparatus includes a controller 910, a short range communication circuit 920, an engine control unit 930, an operation panel 940, and a network I/F 950.

Among these, the controller 910 includes a CPU 901, a system memory (MEM-P) 902, a northbridge (NB) 903, a south bridge (SB) 904, an ASIC (Application Specific Integrated Circuit) 906, a local memory (MEM-C) 907 that is a storage unit, a HDD controller 908, and a HD 909 that is a storage unit, that are main portions of a computer, and the NB 903 and the ASIC 906 are connected by an AGP (Accelerated Graphics Port) bus 921.

Among these, the CPU 901 is a control unit that performs overall control of the image forming apparatus. The NB 903 is a bridge for connecting the CPU 901 to the MEM-P 902, the SB 904, and the AGP bus 921, and the NB 903 has a memory controller for controlling the reading and writing of data from and to the MEM-P 902, a PCI (Peripheral Component Interconnect) master, and an AGP target.

The MEM-P 902 includes the ROM 902a, which is a memory for storing programs and data for implementing each function of the controller 910, and the RAM 902b, which is used for loading programs and data and is used as a rendering memory for memory printing. The program stored in the RAM 902b may be provided upon being recorded in a computer-readable recording medium such as a compact disc read-only memory (CD-ROM), a CD recordable (CD-R), or a digital versatile disc (DVD) in a file in an installable format or an executable format.

The SB 904 is a bridge for connecting the NB 903 to PCI devices and peripheral devices. The ASIC 906 is an integrated circuit (IC) for image processing applications having hardware elements for image processing, and serves as a bridge connecting the AGP bus 921, the PCI bus 922, the HDD controller 908, and the MEM-C 907, respectively. The ASIC 906 includes a PCI target and an AGP master, an arbiter (ARB) that forms the core of the ASIC 906, a memory controller that controls the MEM-C 907, a plurality of Direct Memory Access Controllers (DMACs) that rotate image data by hardware logic or the like, and a PCI unit that transfers data between a scanner unit 931, a printer unit 932, and a facsimile unit through the PCI bus 922. The ASIC 906 may have an interface of the USB (Universal Serial Bus) or the IEEE 1394 (Institute of Electronic and Electronic Engineers 1394).

The MEM-C 907 is a local memory used as an image buffer and a code buffer for copying. The HD 909 is a storage for storing image data, storing font data used for printing, and storing forms. The HD 909 controls the reading or writing of data from or to the HD 909 according to the control of the CPU 901. The AGP bus 921 is a bus interface for graphics accelerator cards proposed to speed up graphics processing, and can speed up graphics accelerator cards by directly accessing the MEM-P 902 with high throughput.

The short range communication circuit 920 is provided with an antenna 920a of the short range communication circuit. The short range communication circuit 920 is a communication circuit of, for example, an NFC, Bluetooth (registered trademark), or the like.

The engine control unit 930 further includes a scanner unit 931, a printer unit 932, and a facsimile unit 933. The operation panel 940 includes a panel display unit 940a, such as a touch panel, for displaying a current setting value, a selection screen, or the like, and receiving input from an operator, and the operation panel 940 includes hard keys 940b, such as a numeric pad, for receiving a setting value of an image forming condition, such as a density setting condition, and a start key for receiving a copy start instruction. The controller 910 controls the entire image forming apparatus and controls, for example, rendering, communication, input from the operation panel 940, and the like. The scanner unit 931 or the printer unit 932 includes an image processing unit for performing image processing such as error diffusion or gamma conversion.

In the image forming apparatus, the application switching key of the operation panel 940 allows sequential switching of the document box function, the copy function, the printer function, and the fax function, so that one of these functions can be selected. When the document box function is selected by the user, the document box mode is set, when the copy function is selected by the user, the copy mode is set, when the printer function is selected by the user, the printer mode is set, and when the fax function is selected by the user, the fax mode is set.

The network I/F 950 is an interface for performing data communication using the communication network N. The short range communication circuit 920 and the network I/F 950 are electrically connected to the ASIC 906 via a PCI bus 922.

### <Functions>

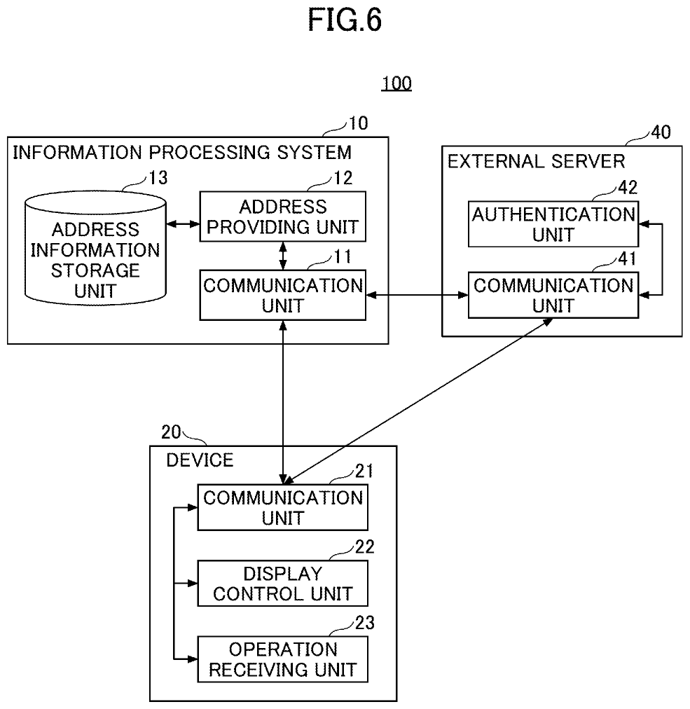

Next, a functional configuration of the device using system 100 according to the present embodiment will be described with reference to FIG. 6. FIG. 6 is a diagram illustrating an example of functional configuration of the device using system 100 according to the present embodiment.

### <<Device>>

The device 20 includes a communication unit 21, a display control unit 22, and an operation receiving unit 23. Each of these functional units of the device 20 is a function or means which is implemented by the CPU 901 executing instructions included in one or more programs installed in the device 20. This program may be a web browser, a native application, or both.

The communication unit 21 transmits and receives various kinds of information to and from the information processing system 10 or the external server 40. According to the present embodiment, the communication unit 21 transmits an authentication request to the information processing system 10, redirects the request to the external server 40, and performs communication regarding the authentication.

The display control unit 22 interprets screen information, such as an authentication screen transmitted from the external server 40, and displays a web page in the web page section 220 of the panel display unit 940a. Screen information is a program described in Hyper Text Markup Language (HTML), eXtensible Markup Language (XML), scripting language, cascade style sheets (CSS), and the like. The structure of a web page is mainly defined by HTML, the scripting language defines the operation of a web page, and CSS defines the style of a web page.

The display control unit 22 displays the device display sections 230 and 240 on the panel display unit 940a by combining display components prepared by the native application. The display control unit 22 displays the web page section 220 and the device display sections 230 and 240 on the panel display unit 940a simultaneously. From the user, the web page section 220 and the device display sections 230 and 240 appear as one screen.

The operation receiving unit 23 receives various operations of a user in various screens displayed on the panel display unit 940a.

### <<Information Processing System>>

The information processing system 10 includes a communication unit 11 and an address providing unit 12. Each of the functional units of the information processing system 10 is a function or means that is implemented by the CPU 501 by executing instructions included in one or more programs installed in the information processing system 10.

The communication unit 11 transmits and receives various kinds of information with the device 20 and the external server 40. According to the present embodiment, in response to an authentication request transmitted from the device 20, the communication unit 11 transmits, to the device 20, information that redirects the device 20 to the external server 40.

The address providing unit 12 provides the device 20 with the URL of the reload destination stored in an address information storage unit 13 included in the information processing system 10.

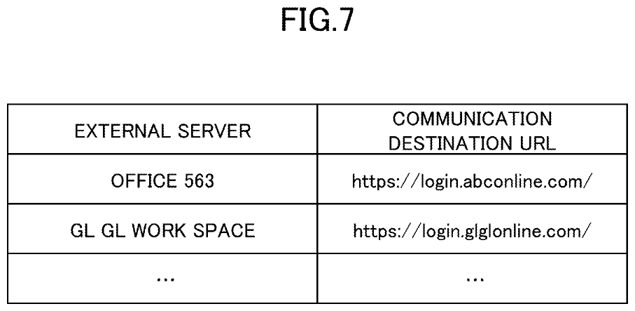

FIG. 7 is an example of the address information stored in the address information storage unit 13. In the address information, a connection destination URL corresponding to the type of the external server 40 is registered. The type of the external server 40 is the external server 40 for authentication that is available for use to the information processing system 10. The connection destination URL can be acquired by the device 20 by pressing the reload button 210, and the web browser of the device 20 is connected to the connection destination URL according to the pressing of the reload button 210. The connection destination URL may be the same as the connection destination to which the device 20 is redirected by OAuth.

The address information illustrated in FIG. 7 can be set in advance by the administrator.

### <<External Server>>

Referring back to FIG. 6, an explanation will be given. The external server 40 includes a communication unit 41 and an authentication unit 42. Each of these functions provided by the external server 40 is a function or means implemented by the CPU 501 executing instructions included in one or more programs installed on the external server 40.

The communication unit 41 transmits and receives various kinds of information with the device 20 and the information processing system 10. In the present embodiment, the communication unit 41 receives the authentication information or the like (the user's ID, password, or the like) from the device 20 and transmits an access token or the like.

The authentication unit 42 authenticates the user based on the OAuth mechanism. Note that it is assumed that the account (user ID, password, etc.) of the user is set in advance to the external server 40.

### <Display of Authentication Screen>

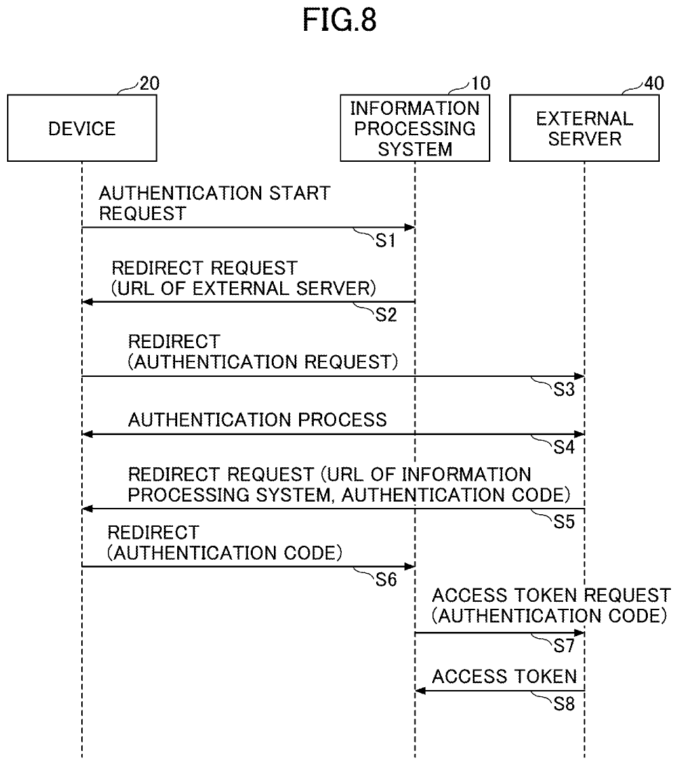

FIG. 8 is an example of a sequence diagram illustrating a procedure in which the device 20 communicates with the external server 40 to have the external server 40 authenticate the user. In FIG. 8, only the main processing of OAuth is illustrated, but there may be processing steps in addition to the steps illustrated.

S1: When the user operates the device 20 to start authentication, the operation receiving unit 23 receives this operation and the communication unit 21 of the device 20 transmits an authentication start request to the information processing system 10.

S2: The communication unit 11 of the information processing system 10 receives the authentication start request and requests the device 20 to redirect to the external server 40 together with the type of the external server 40 (the name of the external server 40 registered in the address information and the connection destination URL). When there are a plurality of external servers 40 that perform authentication, the communication unit 11 may determine the external server 40 to be the redirection destination based on information specifying the external server 40 included in the authentication start request, or the external server 40 to be the redirection destination may be determined in advance in the information processing system 10.

S3: The communication unit 21 of the device 20 receives the redirect request, and the display control unit 22 displays a selection screen for selecting the external server 40. When the user selects the external server 40, the operation receiving unit 23 receives the selection and the communication unit 21 connects to the external server 40 at the redirection destination. However, the display control unit 22 may omit the display of the selection screen, and the communication unit 21 may immediately connect to the external server 40 that is the redirection destination.

S4: When the device 20 is connected to the external server 40, the user ID and password are transmitted from the device 20 to the external server 40, authentication is performed by the authentication unit 42 of the external server 40, the authority to be authorized is set, the authentication result is transmitted from the external server 40 to the device 20, and the like. Here, the external server 40 transmits screen information including a field for inputting the user's ID and password and screen information indicating an authentication result to the device 20, and the device 20 can display a screen based on the received screen information. However, the device 20 may display part of or the entire screen based on the screen information stored in the device 20 or the screen information received from the information processing system 10.

S5: The communication unit 41 of the external server 40 transmits, to the device 20, a redirect request (including an authentication code) in which the information processing system 10 is a redirection destination.

S6: The communication unit 21 of the device 20 receives the redirect request and the specifies authentication code to redirect to the information processing system 10.

S7: The communication unit 11 of the information processing system 10 receives the authentication code and specifies the authentication code to request an access token to the external server 40. The external server 40 identifies the user associated with the authentication code and the authority of the user.

S8: The communication unit 41 of the external server 40 requests an access token to the information processing system 10. The access token indicates that the data of the authenticated user of the device 20 is permitted to be used. Accordingly, the information processing system 10 can access user information (e.g., cloud storage files and the like) by the authority of the user.

In FIG. 8, although the procedure in which the device 20 displays the authentication screen in the procedure of OAuth has been described, the device 20 may directly communicate with the external server 40 to display the authentication screen without involving the information processing system 10.

Further, in the present embodiment, the authentication screen is mainly used as the example in the description, but the web page displayed by the device 20 may display any kind of information. The web page displayed by the device 20 may be based on screen information acquired from the external server 40 or may be based on screen information acquired from the information processing system 10.

### <Reload Button Display Procedure>

By process illustrated in FIG. 8, a screen as illustrated in FIG. 2 is displayed on the panel display unit 940a of the device 20. Here, the content of the web page section 220 may vary depending on the URL to which the device is connected, and FIG. 2 is merely an example.

When a web page is displayed in the web page section 220, there may be cases where the user is unable to cause the screen transition for some reason. Accordingly, the device 20 displays the reload button 210 in the device display sections 230 and 240 in which the display contents can be controlled at the device 20.

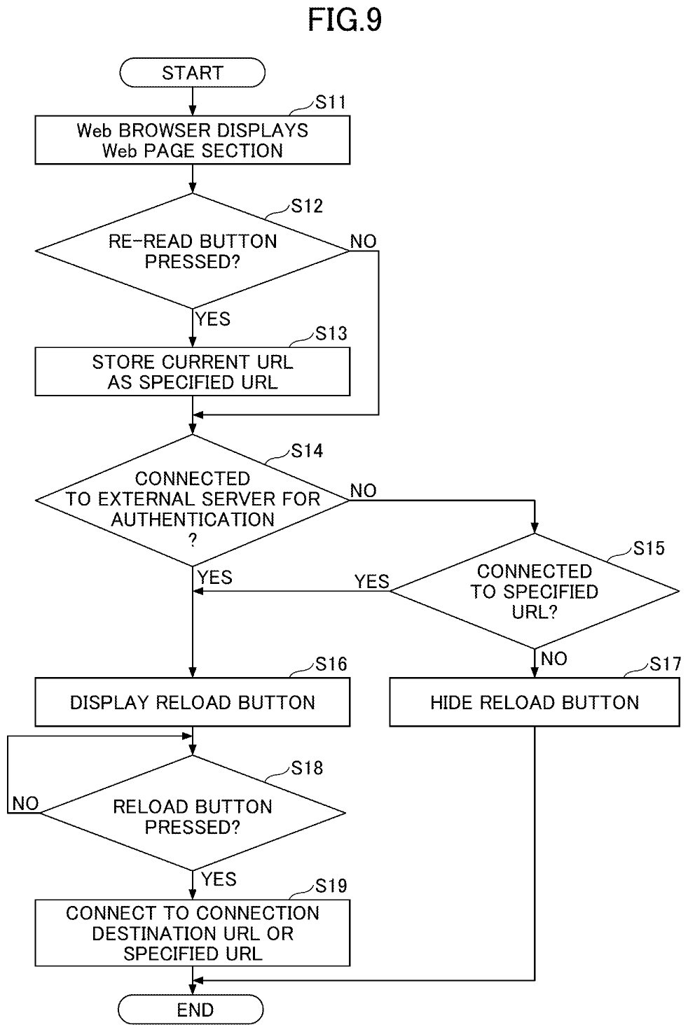

FIG. 9 is an example of a flowchart illustrating a procedure in which the device 20 displays the reload button 210. The processing of FIG. 9 starts when the display control unit 22 displays the web page on the panel display unit 940a (before and after display of the web page and in parallel with the display processing of the device display section).

First, the display control unit 22 interprets the screen information of the authentication screen transmitted from, for example, the external server 40, generates a web page, combines the web page with the device display sections 230 and 240, and displays the page on the panel display unit 940a (S11). It is assumed that the positions of the web page section 220 and the device display sections 230 and 240 are set in advance.

Next, it is determined whether the operation receiving unit 23 has received the operation of pressing a re-read button 250 (S12). The re-read button 250 is a button that allows the device 20 to receive screen information again from the currently displayed URL and re-display the web page. The re-read button 250 can be displayed at a position in the web page section 220, but is not limited thereto. The re-read button 250 can be displayed in the device display sections 230 and 240 or can be installed as a hardware key. Further, although the case where the reload button 210 and the re-read button 250 are respectively provided will be described below, the reload button 210 may have a function of the re-read button 250. In this case, the re-read button 250 may be omitted.

When the determination of step S12 is YES, the operation receiving unit 23 stores the current URL up to the domain as a specified URL (S13). This is because in a case where the user presses the re-read button 250, there is a possibility that an inconvenience has occurred in the screen transition. The current URL up to the domain is stored because, when the user presses the re-read button 250, the device 20 may already be displaying a URL in which operations cannot be continued. A domain is a name for identifying a computer or a network that exists on the Internet. For example, in the case of http://sample.com/index.html, the domain corresponds to sample.com.

Next, the display control unit 22 determines whether the device 20 is connected to the external server 40 for authentication (S14). For this reason, the communication unit 21 acquires the address information in the address information storage unit 13 from the information processing system 10. The display control unit 22 can compare the connection destination URL associated with the external server 40 of the acquired address information (if there are a plurality of URLs, one of the plurality of URLs) with the current connection destination URL, to determine whether a connection is made to the external server 40 for authentication. The result of this comparison is not required to be perfectly identical, as long as the domains are identical.

When the determination of step S14 is NO, it is determined whether the device 20 is connected to the specified URL (S15).

In the case of YES in step S14, or in the case of YES in step S15, the display control unit 22 displays the reload button 210 in the device display sections 230 and 240 (S16). Accordingly, while the web page section 220 is displaying the authentication screen by the external server 40, the device 20 can constantly display the reload button 210. The reload button 210 can be displayed while the device 20 is displaying the screen of the URL in which the user has pressed the re-read button 250.

The display control unit 22 may change the display mode of the reload button 210, between the case of YES in step S14 and the case of YES in step S15. That is, the display control unit 22 changes the display mode of the reload button 210, between the case while the authentication screen is being displayed by the external server 40 and the case while the screen in which the re-read button 250 is pressed is being displayed. For example, it is not necessarily necessary to press the reload button 210 while the authentication screen is being displayed, and, therefore, the display control unit 22 displays the reload button 210 with normal brightness. When the screen in which the re-read button 250 has been pressed is being displayed, there is a possibility that the screen transition may be hindered, and, therefore, the display control unit 22 displays the reload button 210 in a highlighted manner. A highlighted manner includes, for example, increasing the brightness, changing the color, increasing the size, flashing, etc. Alternatively, the display control unit 22 may change the display mode of the reload button 210 according to the type of address registered in the address information storage unit 13.

The display control unit 22 may not display the reload button 210 in the case of YES in step S14, but may display the reload button 210 only in the case of YES in step S15. This is because the reload button 210 may not be necessary even while the authentication screen is being displayed by the external server 40.

In the case of YES in step S14, or in the case of YES in step S15, the display control unit 22 prevents the display of (hides) the reload button 210 (S17). In this manner, the device 20 may switch between displaying and hiding the reload button 210 depending on the connection destination to which the device 20 is connected for displaying information. The display control unit 22 may hide the reload button 210 in accordance with the external server 40. Further, when the screen displayed on the web page section 220 is based on the screen information stored in the device 20, the reload button 210 may be hidden.

When the reload button 210 is displayed, the operation receiving unit 23 determines whether the reload button 210 is pressed (S18).

When the reload button 210 is pressed, the communication unit 21 of the device 20 connects to the connection destination URL or the specified URL (S19). When a specified URL is stored, for example, the communication unit 21 connects to the specified URL with priority, for example. The communication unit 21 may connect to the connection destination URL with priority. The pressing of the reload button 210 is detected by the native application, and, therefore, the native application reports to the web browser that the reload button 210 has been pressed.

When the reload button 210 is pressed again (or in the case where a specified URL is not stored, when the reload button 210 is first pressed), the communication unit 21 of the device 20 acquires the connection destination URL from the information processing system 10 and displays the web page of the connection destination URL in the web page section 220 again. In this case, when the device 20 transmits the current URL to the information processing system 10, the address providing unit 12 of the information processing system 10 acquires a connection destination URL having the same domain as the current URL, from the address information storage unit 13. The communication unit 11 transmits the acquired connection destination URL to the device 20. Accordingly, in a situation where screen transition is not possible, the device 20 can display an authentication screen capable of screen transition.

The reload button 210 may be displayed only when the device 20 is redirected. It can be detected that the device 20 has been redirected according to the HTTP status code (300).

<Display Message when Reload Button is Pressed>

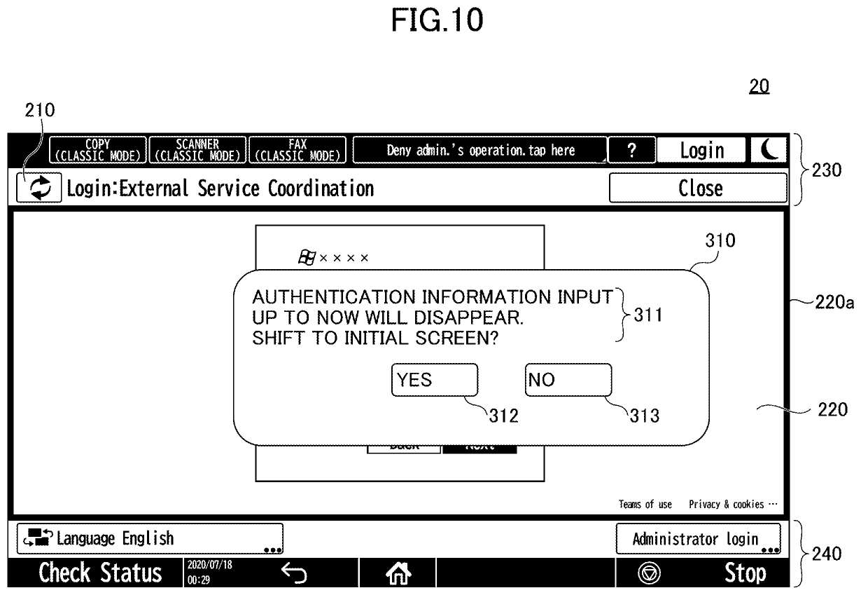

As illustrated in FIG. 10, when the user presses the reload button 210, the display control unit 22 may display a message. FIG. 10 is a diagram illustrating a message displayed when the reload button 210 is pressed.

The display control unit 22 displays a dialog box 310 when the reload button 210 is pressed. The dialog box 310 has a message 311 reading “Authentication information input up to now will disappear. Shift to initial screen?”, a YES button 312, and a NO button 313. The user can read the message 311 to determine whether to cause the screen transition. When the YES button 312 is pressed (by user operation), the communication unit 21 performs the processing in step S19. Such a display is effective when the user accidentally presses the reload button 210 (even though the user does not wish to cause the screen transition).

<Display Reload Button on Screen Other than Authentication Screen>

In the present embodiment, the case where the web browser displays the authentication screen of the external server 40 is described. However, regardless of the contents of the web page displayed in the web page section 220, the device 20 can display the reload button 210.

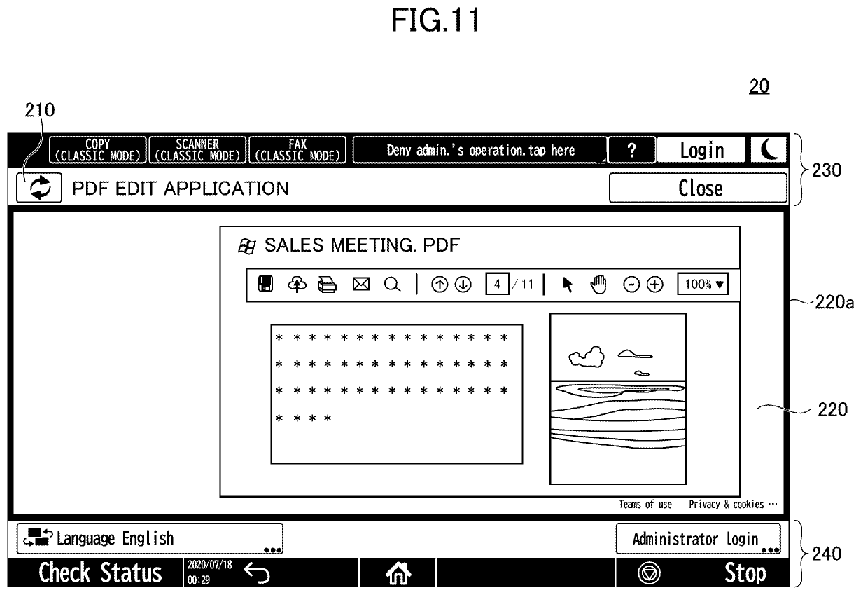

FIG. 11 is an example of an editing drawing displayed on the web page section 220 when the external server 40 provides a PDF editing service. In FIG. 11, it is assumed that a user can edit the PDF by the panel display unit 940a. Such a service is provided for personal computers, and, therefore, the web browser of the device 20 may malfunction. Therefore, it is preferable for the user to return to a regular screen (i.e., to reduce the frequency of contacting the administrator and making service calls).

Also in FIG. 11, the device display sections 230 and 240 display the reload button 210. When the reload button 210 is pressed, the device 20 again displays a web page of a URL suitable for the PDF service being used. If the user has logged in and used the PDF editing service, the device 20 will return to the web page with the PDF file in an open state.

As a method for implementing the above, for example, the communication unit 21 records the URL at least every time the domain of the connected URL is switched. The communication unit 21 preferably records up to the file name when the URL of the connection destination includes a file name. When the reload button 210 is pressed, the communication unit 21 connects to the URL recorded last.

As described above, the URL to which the device 20 is connected by pressing the reload button 210 does not have to be set in advance to the information processing system 10 or the like.

### <Major Effects>

As described above, in the device using system 100 of the present embodiment, the device 20 displays the reload button 210 apart from the web page, and, therefore, even when the screen transitions to a screen from which it is difficult to return to a previous screen while the user is operating the screen, when the user presses the reload button 210, the screen returns to a screen in which operation can be continued.

According to one embodiment of the present invention, a device that displays, in a second area that is different from a first area where the application displays information, a display component that connects to a specified connection destination, is provided.

### <Other Applications>

The device, the display method, and the recording medium are not limited to the specific embodiments described in the detailed description, and variations and modifications may be made without departing from the spirit and scope of the present invention.

For example, if an application by which the user does not use the external server 40 is started in the device 20, instead of the web page section 220, the device 20 may display a screen display section for this application. Even in this case, the device 20 may display the reload button 210 in the device display sections 230 and 240. When the reload button 210 is operated, the device 20 may update the status of the application or restart the application. That is, even when the same reload button 210 is operated, depending on the type of application that is started, the process to be executed may be changed. For example, the display control unit 22 determines whether the application to be started is an application that uses the external server 40. For example, when the application is a native application, the display control unit 22 determines that the application does not use the external server 40, and the device 20 updates the status of the application in accordance with an operation of the reload button 210. Further, for example, in the case of a web application or a web browser application, it is determined that the application uses the external server 40, and the device 20 connects to a specified connection destination in accordance with an operation of the reload button 210. However, the present invention is not limited thereto, and in the case where the application which has been started does not use the external server 40, the display control unit 22 may hide the reload button. That is, the display control unit 22 may switch between displaying and hiding the reload button according to the type of application to be started.

For example, in the present embodiment, the device 20 is connected to the external server 40 by OAuth, but the device 20 may be connected to the external server 40 by any single sign-on mechanism.

The functional block diagram illustrated in FIG. 6 illustrates a division of the blocks as an example, and a plurality of blocks may be implemented as one block, one block may be divided into two or more blocks, and/or some functions may be transferred to other blocks. The functions of multiple blocks with similar functions may also be processed in parallel or by time division by a single piece of hardware or software.

Also, the apparatus group described in the examples are merely indicative of one of a plurality of computing environments for carrying out the embodiments disclosed herein. In some embodiments, the information processing system 10 includes a plurality of computing devices, such as server clusters. The plurality of computing devices are configured to communicate with each other via any type of communication link, including networks, a shared memory, and the like, and perform the processes disclosed herein.

Further, the information processing system 10 can be configured to share various combinations of the processing steps disclosed in the present embodiment, for example, FIG. 8. For example, a process performed by a predetermined unit may be performed by a plurality of information processing apparatuses including the information processing system 10. The information processing system 10 may be organized into a single server apparatus or may be divided into a plurality of apparatuses.

The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC) a digital signal processor (DSP), a field programmable gate array (FPGA), and a conventional circuit module, designed to execute each function as described above.

What is claimed is:

1. A device comprising:
circuitry; and
a memory storing computer-executable instructions that cause the circuitry to execute:
displaying by an application, in a first area of a screen, information received from an information processing apparatus in a network;
displaying, in a second area of the screen different from the first area, a display component that connects to a specified connection destination; and
communicating to connect to the specified connection destination in response to detecting that the display component is pressed, wherein
the displaying includes displaying, in the first area, connection destination information received from the specified connection destination.

2. The device according to claim 1, wherein according to a connection destination to which the device is connected for displaying the connection destination information, the displaying includes switching between displaying and hiding the display component.

3. The device according to claim 1, wherein the circuitry is further caused to execute:
performing communication with an information processing system via the network, wherein
in the information processing system, the specified connection destination that differs according to the information processing apparatus is registered, and
in response to detecting that the display component is pressed, the communicating includes acquiring, from the information processing system, the specified connection destination associated with the information processing apparatus to which the device is connected for displaying the connection destination information, and connecting to the specified connection destination.

4. The device according to claim 1, wherein
in response to detecting that the display component is pressed, the displaying includes displaying a message indicating that the screen will transition, and
according to a user operation, the communicating includes connecting to the specified connection destination.

5. The device according to claim 1, wherein according to a connection destination to which the device is connected for displaying the connection destination information, the displaying includes changing a display mode of the display component.

6. The device according to claim 5, wherein
in response to detecting that a re-read button for re-reading the connection destination information is pressed, the communicating includes storing the connection destination to which the device is connected for displaying the connection destination information, and
in response to detecting that the device is connected to the connection destination for displaying the information, the displaying includes displaying the display component in a highlighted manner.

7. The device according to claim 1, wherein
the communicating includes recording a connection destination every time a domain is switched, and
in response to detecting that the display component is pressed, the communicating includes setting the connection destination as the specified connection destination and connecting to the specified connection destination.

8. The device according to claim 1, wherein
a web browser operates as the application in the device,
a native application operates in the device,
the displaying includes displaying, by the web browser in the first area, the information received from the information processing apparatus and the connection destination information received from the specified connection destination, and
the native application displays the display component in the second area.

9. A display method performed by a device, the display method comprising:
displaying by an application, in a first area of a screen, information received from an information processing apparatus in a network;
displaying, in a second area of the screen different from the first area, a display component that connects to a specified connection destination; and
connecting to the specified connection destination in response to detecting that the display component is pressed, wherein
the displaying includes displaying, in the first area, connection destination information received from the specified connection destination.

10. A non-transitory computer-readable recording medium storing a program that causes a computer to execute a process performed in a device, the process comprising:
displaying by an application, in a first area of a screen, information received from an information processing apparatus in a network;
displaying, in a second area of the screen different from the first area, a display component that connects to a specified connection destination; and
connecting to the specified connection destination in response to detecting that the display component is pressed, wherein
the displaying includes displaying, in the first area, connection destination information received from the specified connection destination.
